(19) United States
(12) Patent Application Publication
(10) Pub. No.: US 2014/0039846 A1
(43) Pub. Date: Feb. 6, 2014

(54) INFORMATION PROCESSING METHOD, INFORMATION PROCESSING DEVICE, AND INFORMATION PROCESSING SYSTEM

(71) Applicant: FUJITSU LIMITED, Kawasaki-shi (JP)

(72) Inventor: Hisashi AOYAMA, Yokohama (JP)

(73) Assignee: FUJITSU LIMITED, Kawasaki-shi (JP)

(21) Appl. No.: 13/903,326

(22) Filed: May 28, 2013

(30) Foreign Application Priority Data
Aug. 6, 2012 (JP) 2012-173697

(51) Int. Cl. G06F 17/50

(52) U.S. Cl. CPC G06F 17/5072
USPC 703/1

(57) ABSTRACT

An information processing method, includes: identifying, by a computer, a first components of a first category included in circuit data including a plurality of components, when receiving a first instruction to replace the first components with a second component of a second category; generating layers on which the second component is to be arranged; acquiring correlation between a pin of the first component and a pin of the second component; and replacing the first component with the second component arranged on the layers based on the correlation.

### CROSS-REFERENCE TO RELATED APPLICATION(S)

This application is based upon and claims the benefit of priority of the prior Japanese Patent Application No. 2012-173697, filed on Aug. 6, 2012, the entire contents of which are incorporated herein by reference.

### FIELD

The embodiment discussed herein is related to an information processing method, an information processing device, and an information processing system.

### BACKGROUND

When component change of a generated circuit diagram is performed in a computer-aided design (CAD) system, an automatic replacement function is used.

Related techniques are disclosed in Japanese Laid-open Patent Publication No. 8-180079, Japanese Laid-open Patent Publication No. 6-60156, and Japanese Laid-open Patent Publication No. 2008-140304.

### SUMMARY

According to one aspect of the embodiments, an information processing method, includes: identifying, by a computer, a first components of a first category included in circuit data including a plurality of components, when receiving a first instruction to replace the first components with a second component of a second category; generating layers on which the second component is to be arranged; acquiring correlation between a pin of the first component and a pin of the second component; and replacing the first component with the second component arranged on the layers based on the correlation.

The object and advantages of the invention will be realized and attained by means of the elements and combinations particularly pointed out in the claims.

It is to be understood that both the foregoing general description and the following detailed description are examples and explanatory and are not restrictive of the invention, as claimed.

### BRIEF DESCRIPTION OF DRAWINGS

FIG. 1 illustrates an example of a component category;

FIG. 2 illustrates an example of a component category;

FIG. 3 illustrates an example of component replacement;

FIG. 4 illustrates an example of component replacement;

FIG. 5 illustrates an example of a component category;

FIG. 6 illustrates an example of component replacement;

FIG. 7 illustrates an example of a CAD device;

FIG. 8 illustrates an example of support processing of circuit designing;

FIG. 9 illustrates an example of a component designation screen;

FIG. 10 illustrates an example of data which is stored in a component storage unit;

FIG. 11 illustrates an example of data which is stored in a symbol storage unit;

FIG. 12 illustrates an example of a tentative arrangement of a post-replacement component in a work layer;

FIG. 13 illustrates an example of a work layer;

FIG. 14 illustrates an example of a work layer management table;

FIG. 15 illustrates an example of a work layer;

FIG. 16 illustrates an example of association of work layers;

FIG. 17 illustrates an example of correlation of pins;

FIG. 18 illustrates an example of superposition of a post-replacement component and a pre-replacement component;

FIG. 19 illustrates an example of correlation of pins;

FIG. 20 illustrates an example of superposition of a post-replacement component and a pre-replacement component;

FIG. 21 illustrates an example of a pin number correlation table;

FIG. 22 illustrates an example of association cancellation;

FIG. 23 illustrates an example of association cancellation;

FIG. 24 illustrates an example of association cancellation;

FIG. 25 illustrates an example of support processing of circuit designing;

FIG. 26 illustrates an example of replacement processing;

FIG. 27 illustrates an example of replacement processing;

FIG. 28 illustrates an example of data which is stored in a component storage unit after replacement;

FIG. 29 illustrates an example of replacement processing; and

FIG. 30 illustrates an example of a computer.

### DESCRIPTION OF EMBODIMENT

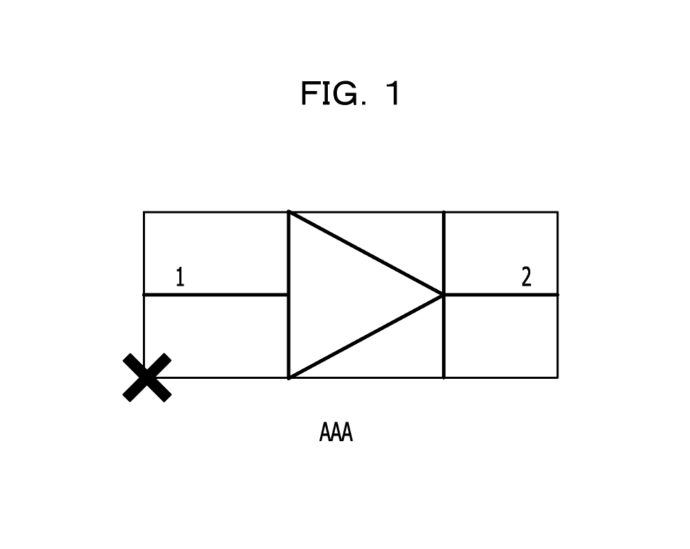

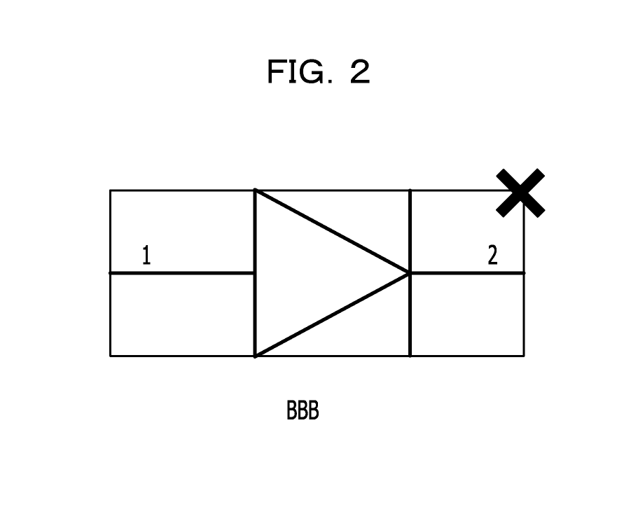

FIGS. 1 and 2 illustrate an example of a component category.

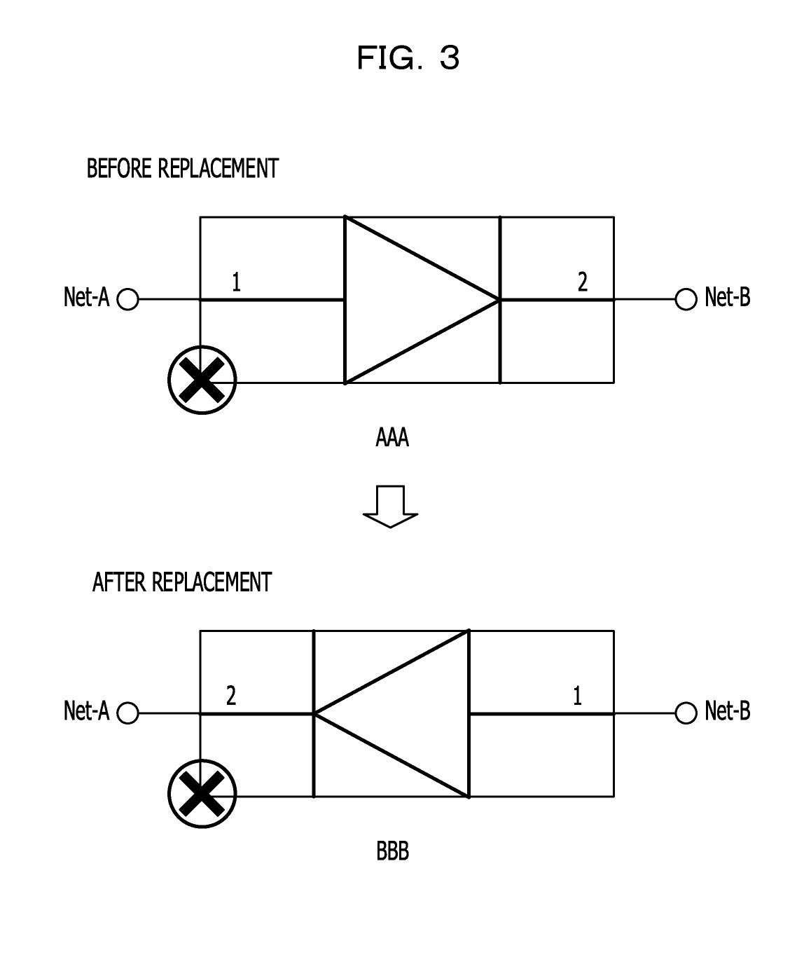

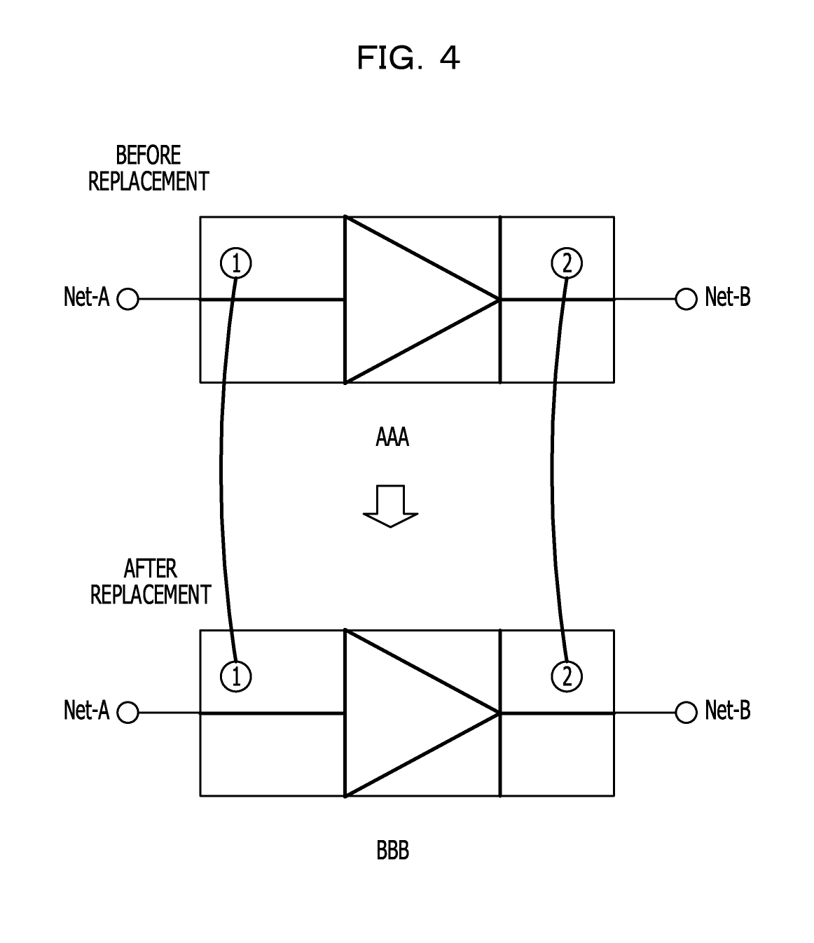

When a component category “AAA” depicted in FIG. 1 is replaced with a component category “BBB” depicted in FIG. 2, for example, the replacement may be performed so as to accord reference points (x mark) of components which are registered in a library of component symbols. A diode depicted in FIGS. 1 and 2 carries significance in a direction of the component. FIGS. 3 and 4 illustrate an example of component replacement. As depicted in FIG. 3, when replacement is performed in a manner to accord reference points, a direction of the component may be inverted after the replacement and correct replacement of the component may not be performed.

In FIG. 4, a component is automatically replaced in a direction in which pin numbers are accorded with each other. The replacement is performed so that a first pin of a pre-replacement component and a first pin of a post-replacement component face same directions in a combination and a second pin of the pre-replacement component and a second pin of the post-replacement component face same directions in a combination. Meaning of a circuit may not be changed between before and after the replacement of components.

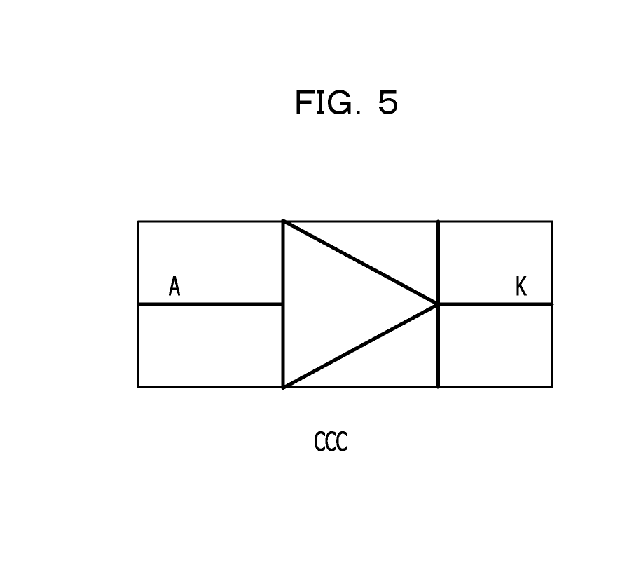

For example, a representing method of a pin number may vary depending on a creator of a circuit library of a circuit CAD system. For example, pin numbers which are number 1 and number 2 may be provided to diodes as depicted in FIG. 1. FIG. 5 illustrates an example of a component. As depicted in FIG. 5, pin numbers which are represented in function names such as an anode A and a cathode K may be provided.

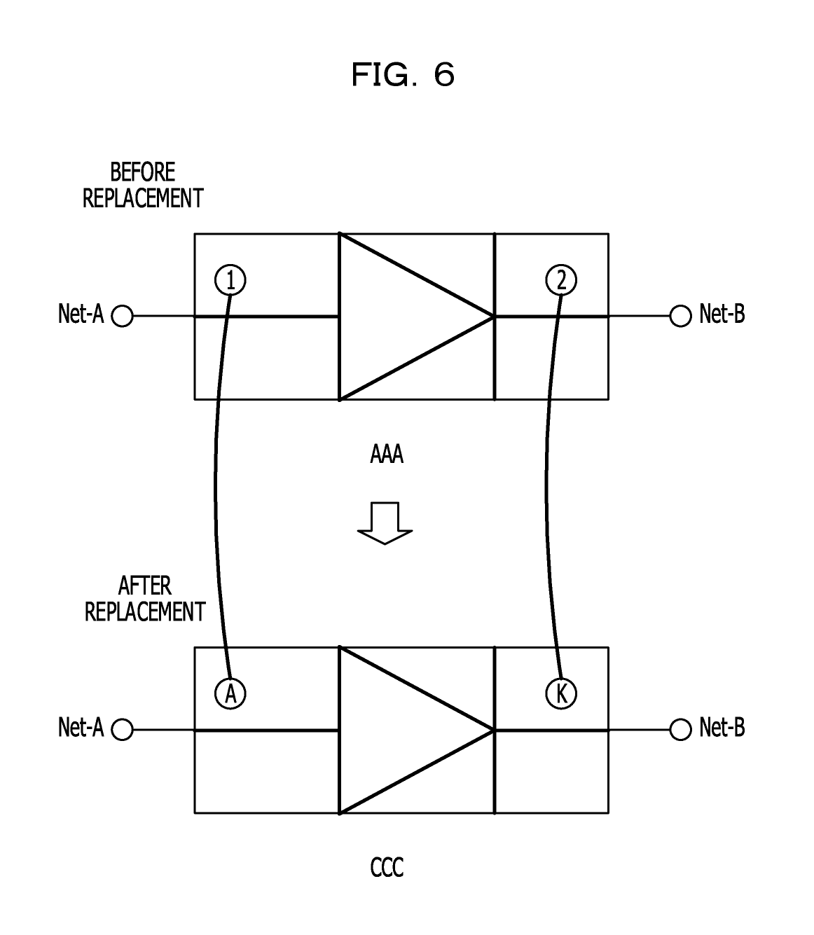

When representing methods of a pin number are different from each other, replacement may not be performed under the condition “pin numbers are accorded with each other”. FIG. 6 illustrates an example of component replacement. As depicted in FIG. 6, a human may instruct a first pin of a pre-replacement component and an A pin of a post-replacement component in a combination to face the same direction and instruct a second pin and a K pin in a combination to face the same direction.

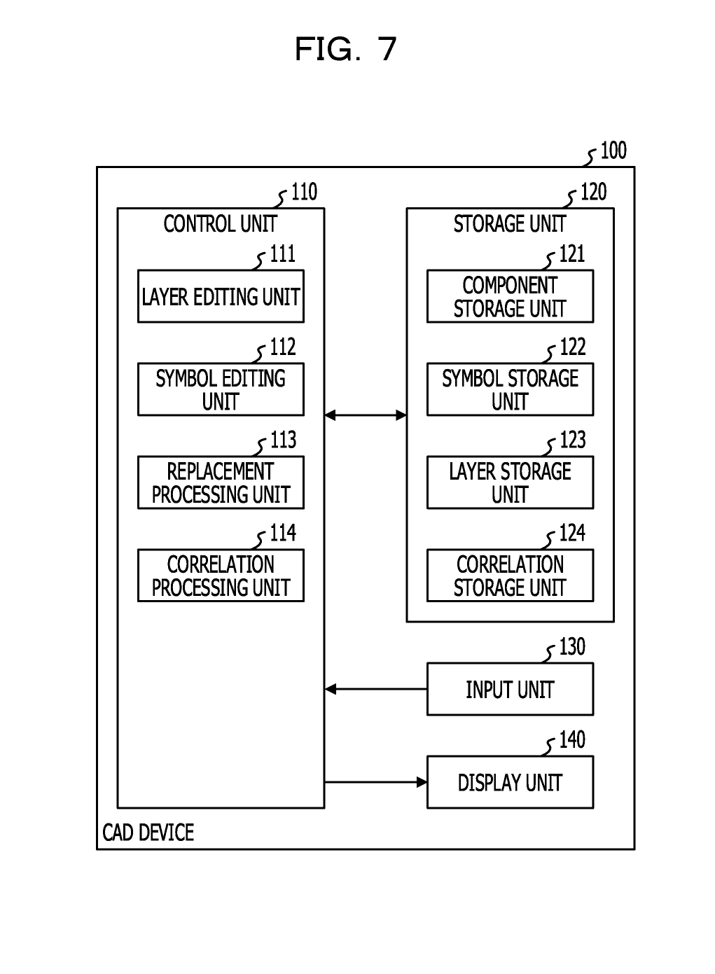

FIG. 7 illustrates an example of a CAD device. A CAD device 100 includes a control unit 110, a storage unit 120, an input unit 130, and a display unit 140. The control unit 110 includes a layer editing unit 111, a symbol editing unit 112, a replacement processing unit 113, and a correlation processing unit 114. The storage unit 120 includes a component storage unit 121, a symbol storage unit 122, a layer storage unit 123, and a correlation storage unit 124.

The layer editing unit 111 generates data of a work layer. The correlation processing unit 114 specifies correlation between a pin of a pre-replacement component and a pin of a post-replacement component. The symbol editing unit 112 processes a symbol of a post-replacement component to associate the symbol of the post-replacement component with a symbol of a pre-replacement component in accordance with correlation of pins, so as to arrange the symbol of the post-replacement component in a work layer. The replacement processing unit 113 replaces a post-replacement component arranged on a work layer and a pre-replacement component in a circuit diagram with each other.

The symbol storage unit 122 stores data of symbols of respective components. The component storage unit 121 stores data of components which are included in a circuit diagram. The layer storage unit 123 stores data about a work layer. The correlation storage unit 124 stores data about correlation between a pin number of a pre-replacement component and a pin number of a post-replacement component.

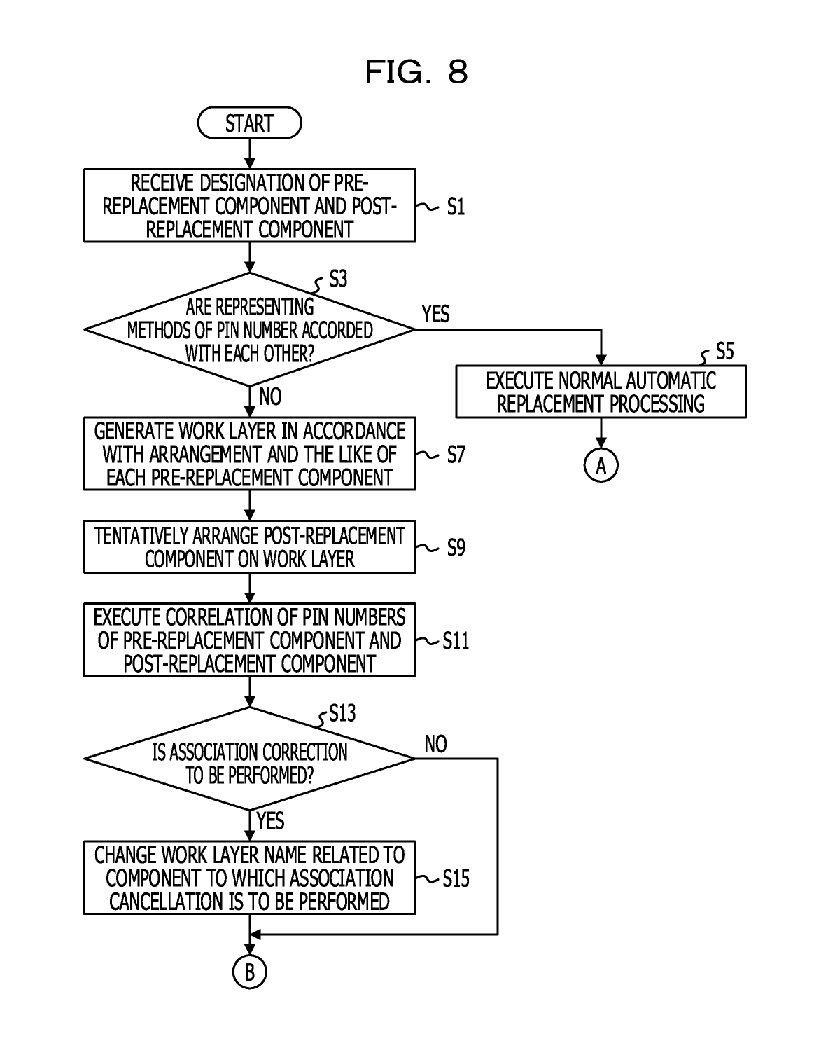

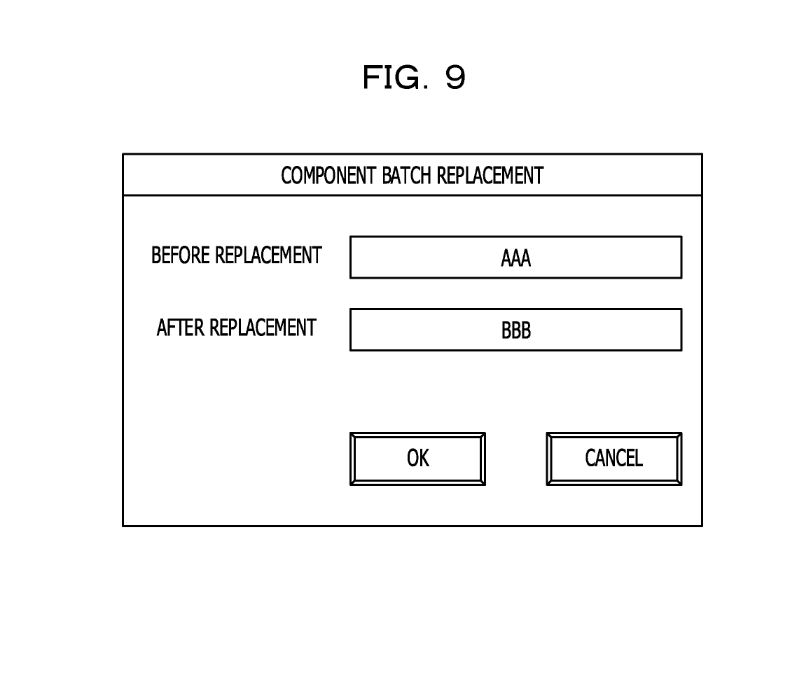

FIG. 8 illustrates an example of a support processing of circuit designing. FIG. 9 illustrates an example of a component designation screen.

The control unit 110 allows the display unit 140 to display a component designation screen depicted in FIG. 9, for example, in accordance with a component replacement instruction which is inputted from the input unit 130 and receives designation of a pre-replacement component and a post-replacement component from a user (FIG. 8: operation S1). In FIG. 9, a category of the pre-replacement component is “AAA” and a category of the post-replacement component is “BBB”.

The control unit 110 determines whether representing methods of a pin number are accorded with each other, based on data of a symbol of the pre-replacement component “AAA” (including data of a pin number) and data of a symbol of the post-replacement component “BBB” (including data of a pin number) that are stored in the symbol storage unit 122 (operation S3). When the representing methods of a pin number are accorded with each other, the control unit 110 executes normal automatic replacement processing (operation S5). For example, processing of rotating a symbol of a post-replacement component is performed so that pin numbers of a pre-replacement component and the post-replacement component are accorded with each other. Then, the pre-replacement component is replaced with the post-replacement component. The processing is ended via a terminal A. The end processing may be substantively same as or similar to processing of related art.

When the representing methods of a pin number are not accorded with each other, the layer editing unit 111 specifies respective pre-replacement components by using data, which is stored in the component storage unit 121, of components included in a circuit diagram and data, which is stored in the symbol storage unit 122, of sizes of pre-replacement components, and generates work layers in accordance with an arrangement and the sizes of the pre-replacement components, so as to store data of the work layers in the layer storage unit 123 (operation S7).

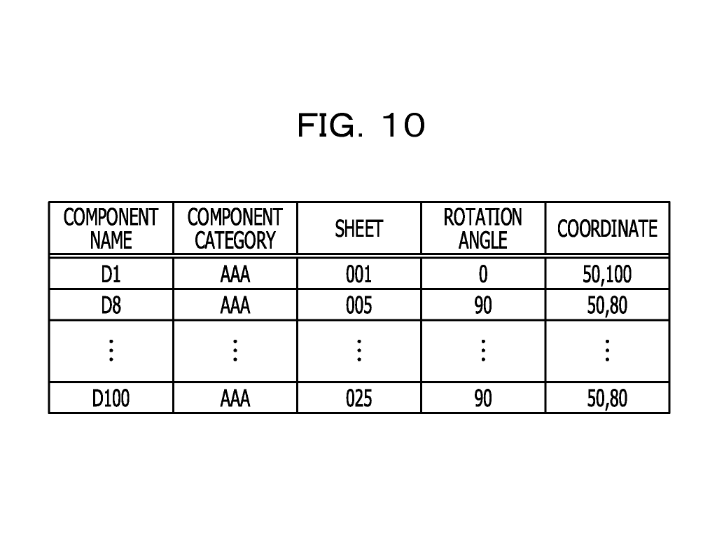

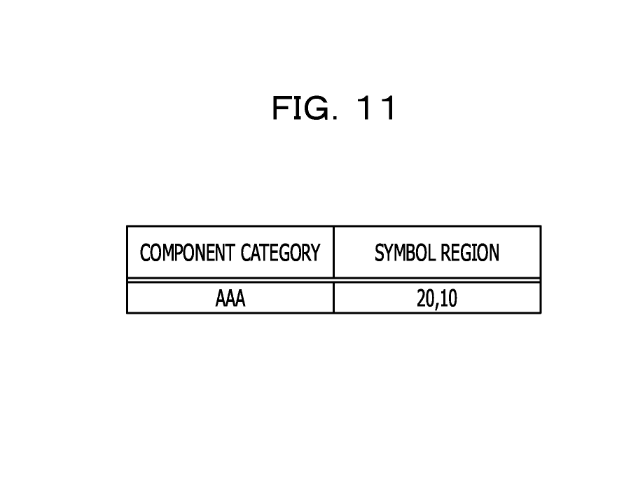

FIG. 10 illustrates an example of data which is stored in a component storage unit. The layer editing unit 111 extracts data depicted in FIG. 10, for example, from the component storage unit 121 so as to specify each pre-replacement component. In FIG. 10, a component name, a component category, a sheet number, a rotation angle, and a coordinate are included for each component. Data on the component category “AAA” is extracted. FIG. 11 illustrates an example of data which is stored in a symbol storage unit. The layer editing unit 111 reads data including a component category and a symbol region (size), which are depicted in FIG. 11, for example, from the symbol storage unit 122. Data of an image of a symbol and a pin number of each pin are further stored in the symbol storage unit 122. Coordinate data of each pin may be held.

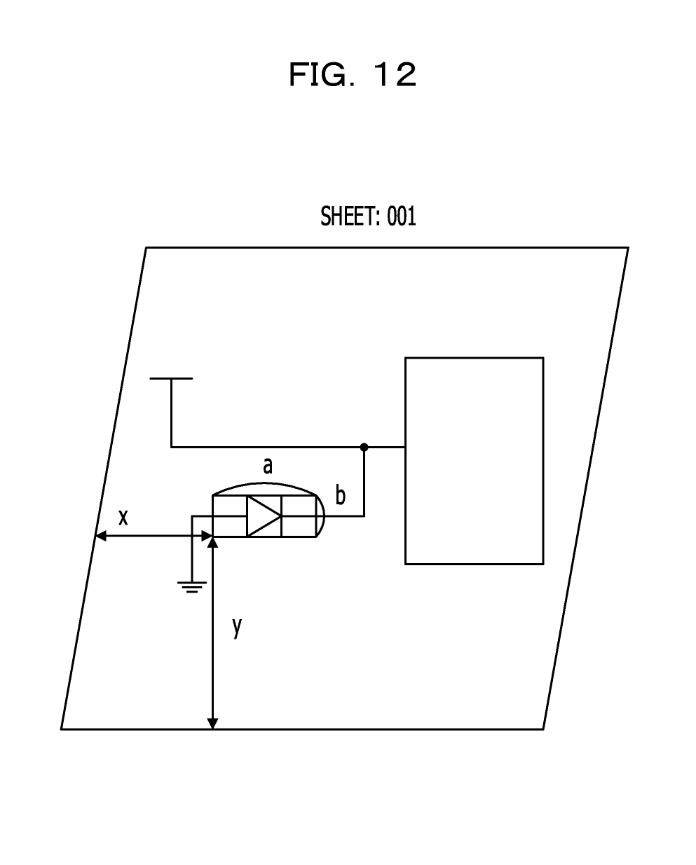

FIG. 12 illustrates an example of a tentative arrangement of a post-replacement component in a work layer. As depicted in FIG. 12, a work layer having a shape which is defined by a symbol region (size) (a, b) from a reference point which is on a position corresponding to a coordinate (x, y) of each pre-replacement component from an origin on the lower left, for example, is generated. When a rotation angle is set, a work layer may be rotated by the rotation angle about the reference point.

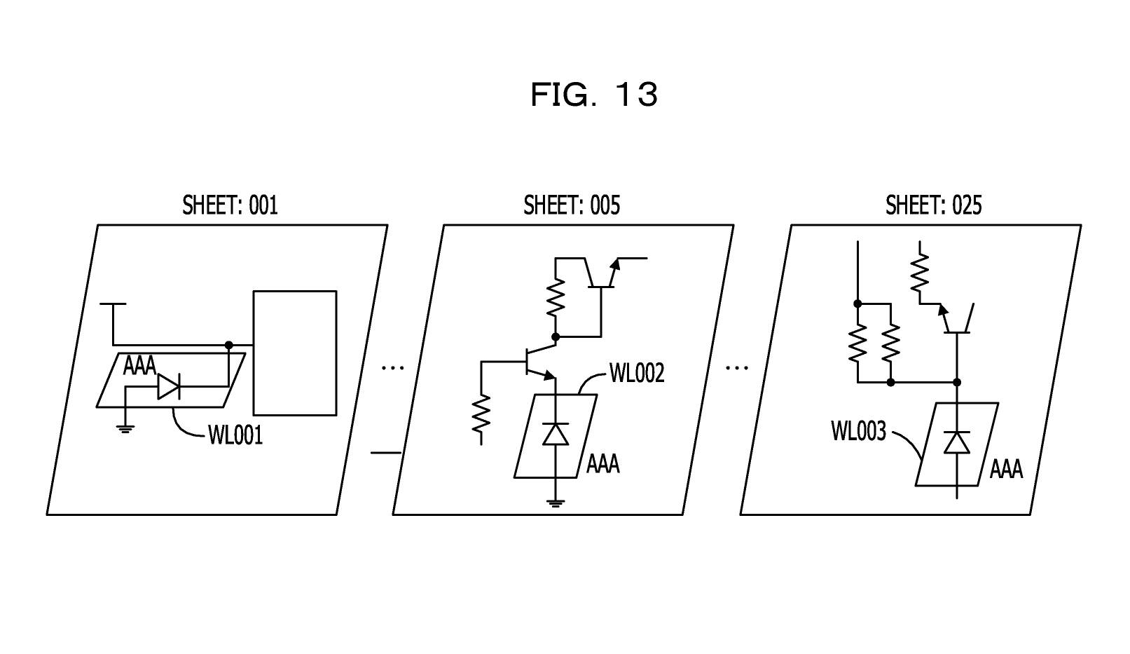

FIG. 13 illustrates an example of a work layer. FIG. 13 schematically illustrates work layers which are generated in a manner to correspond to respective pre-replacement components. With respect to a diode which is a pre-replacement component, a work layer WL001 is generated in a sheet: 001, a work layer WL002 is generated in a sheet: 005, and a work layer WL003 is generated in a sheet: 025.

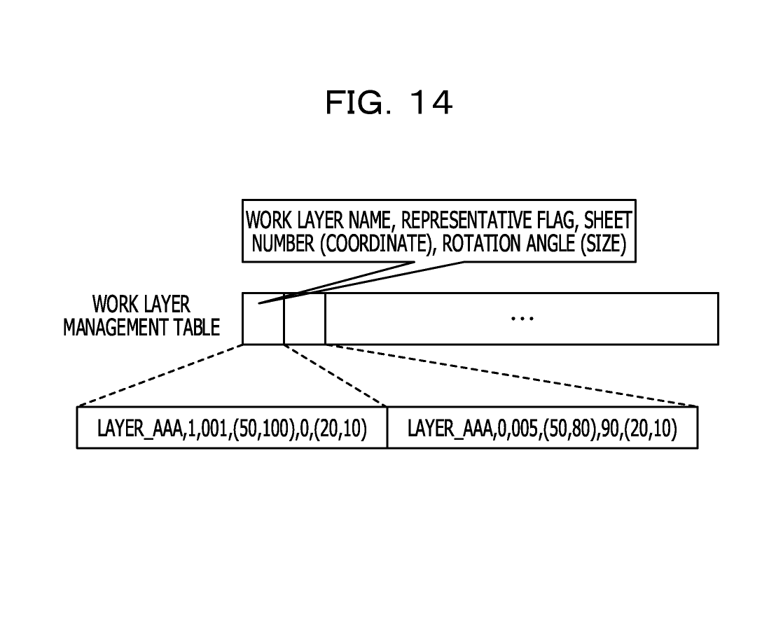

FIG. 14 illustrates an example of a work layer management table. A work layer management table depicted in FIG. 14 is stored in the layer storage unit 123. In FIG. 14, a work layer name which is common in pre-replacement components, a representative flag, a sheet number, a coordinate, a rotation angle, and a size are stored with respect to each specified pre-replacement component. In FIG. 14, a work layer name “LAYER_AAA” may be common, and data of a work layer corresponding to the sheet number “001” and data of a work layer corresponding to the sheet number “005” are represented. A coordinate value, a rotation angle, and a size are represented in FIGS. 10 and 11. A circuit diagram may be expanded to be depicted in a plurality of sheets or may be depicted a single sheet.

Identical work layer names are registered in the work layer management table, thus associating work layers with each other.

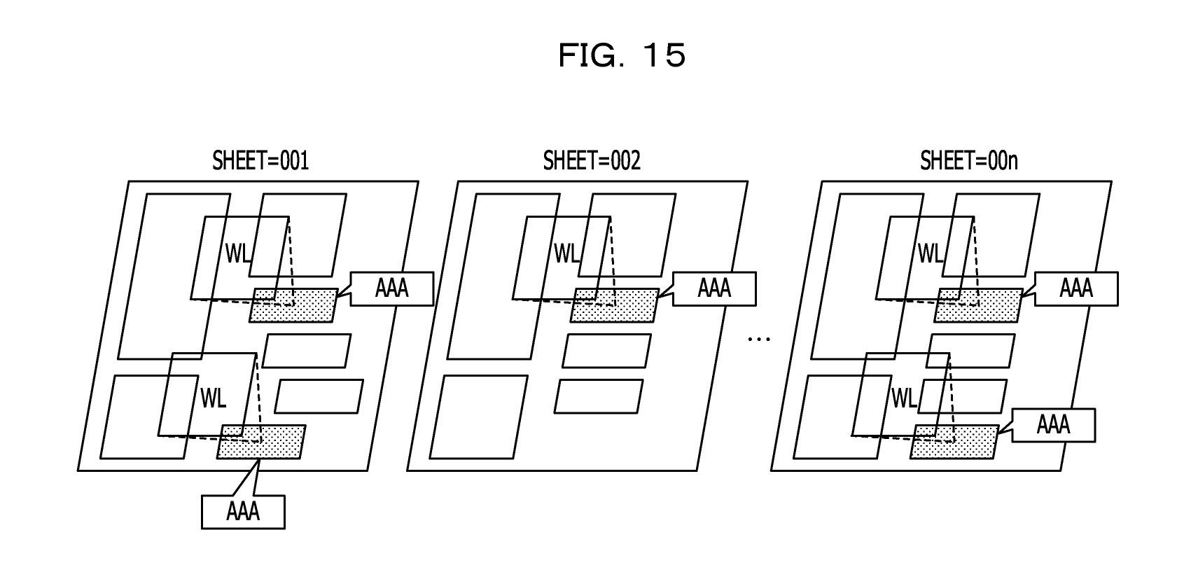

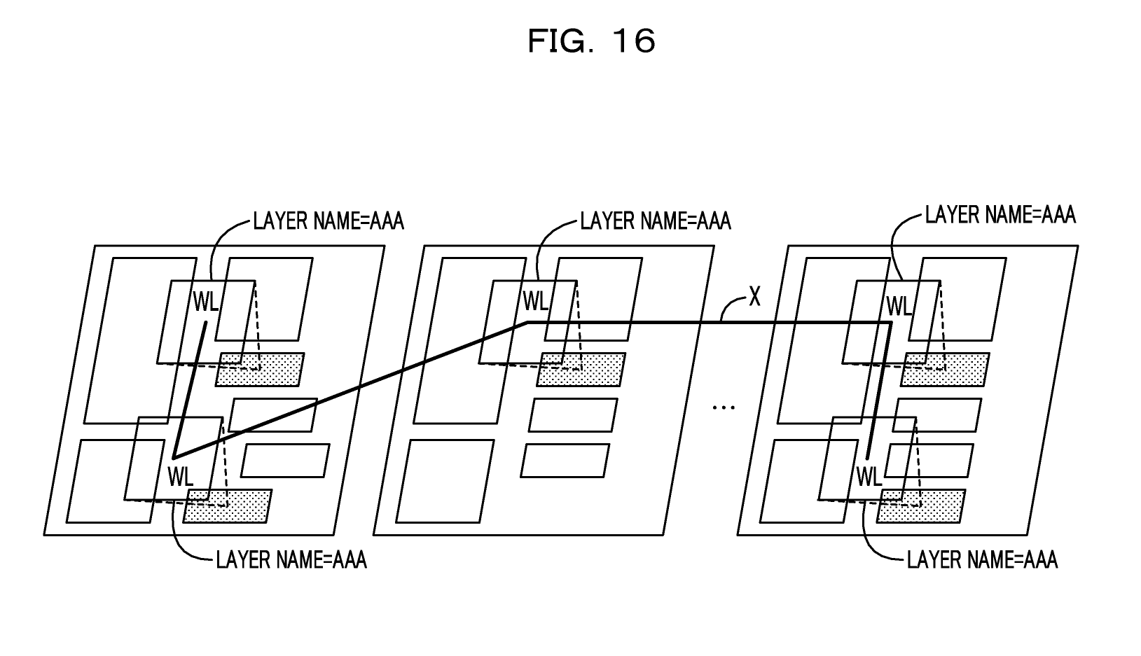

FIG. 15 illustrates an example of a work layer. FIG. 16 illustrates an example of association of work layers. A work layer WL is generated for each pre-replacement component of the category “AAA” of each sheet depicted in FIG. 15. For example, identical work layer names “AAA” depicted in FIG. 16 are provided so as to create association X.

The symbol editing unit 112 reads data of a symbol of a post-replacement component from the symbol storage unit 122. The size of a symbol of a post-replacement component is enlarged or reduced to the size of each work layer and the symbol of the post-replacement component is rotated so that a rotation angle of the symbol of the post-replacement component is accorded with a rotation angle of each work layer, thus tentatively arranging the symbol of the post-replacement component on each work layer (operation S9). Operation S9 may be performed immediately before replacement.

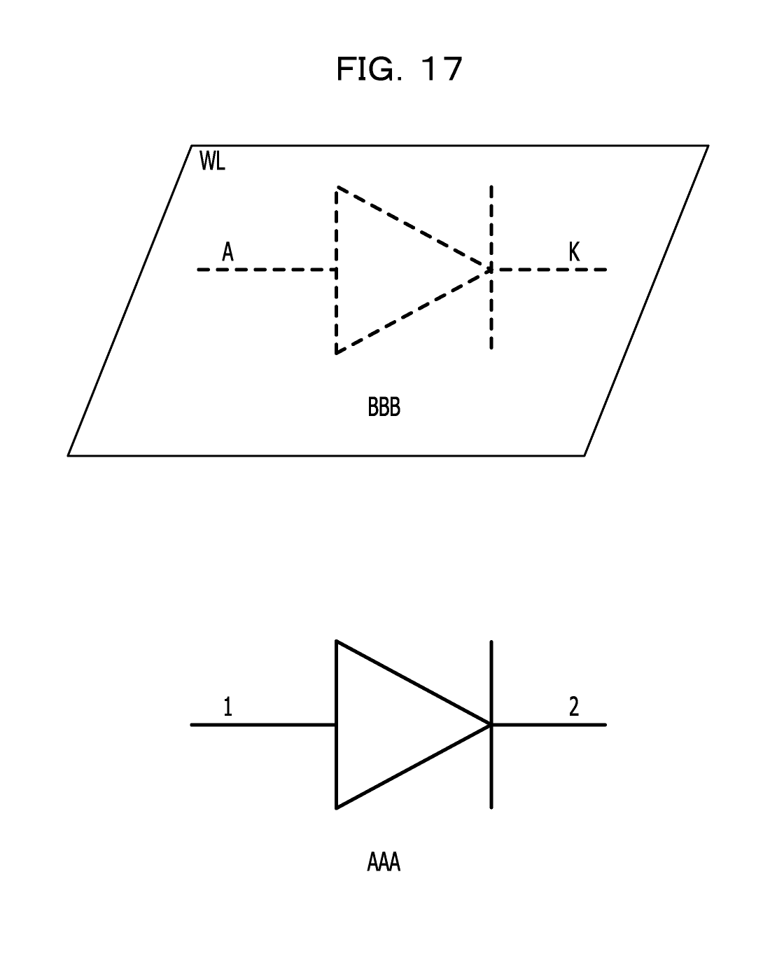

The correlation processing unit 114 correlates a pin number of a pre-replacement component with a pin number of a post-replacement component (operation S11). In operation S11, a user selects one pre-replacement component, displays the pre-replacement component and a post-replacement component which corresponds to the pre-replacement component and is positioned on a work layer, and inputs the correlation, for example. FIG. 17 illustrates an example of correlation of pins.

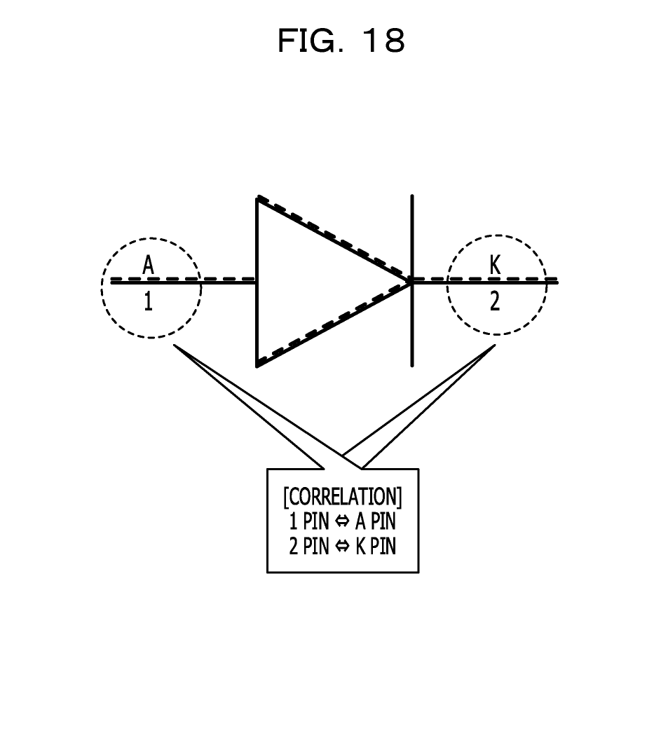

FIG. 18 illustrates an example of superposition of a post-replacement component and a pre-replacement component. For example, when a pin having a pin number “1” of a pre-replacement component is correlated with a pin having a pin number “A” of a post-replacement component and a pin having a pin number “2” of the pre-replacement component is correlated with a pin having a pin number “K” of the post-replacement component, as depicted in FIG. 17, a direction of the post-replacement component is already accorded with a direction of the pre-replacement component. Therefore, an instruction of correlation is directly performed from the input unit 130. The correlation processing unit 114 sets a representative flag with respect to a work layer corresponding to the pre-replacement component which is selected by a user. Another work layer may be selected as a representative work layer and a representative flag may be set. The correlation processing unit 114 directly superposes the post-replacement component and the pre-replacement component on each other on the work layer and determines that the post-replacement component and the pre-replacement component are accorded with each other on identical coordinates, for example, within a certain allowance range, correlating pin numbers with each other. The above-described correlation is obtained as depicted in FIG. 18, as a result of superposition of FIG. 17.

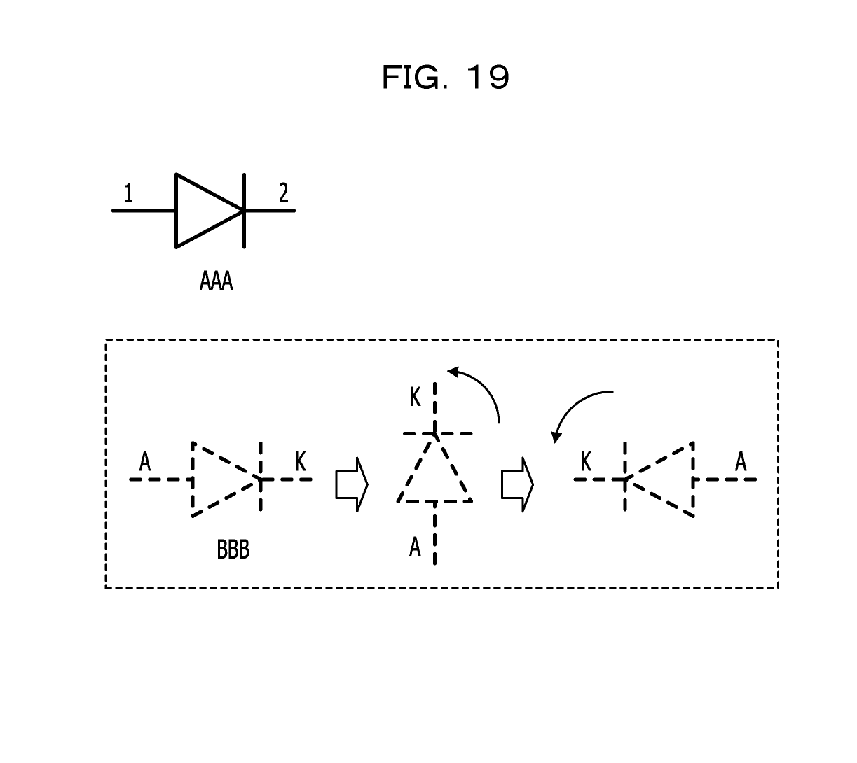

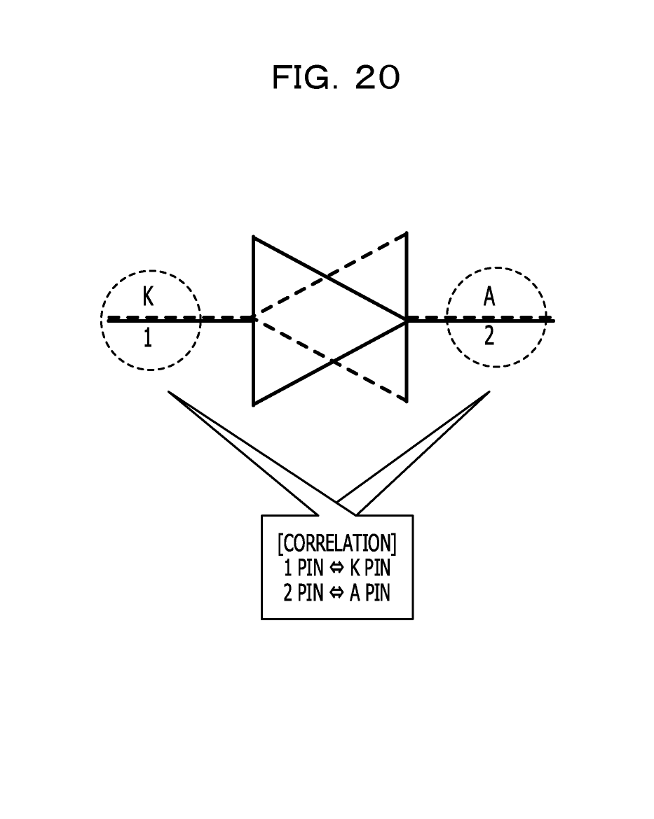

FIG. 19 illustrates an example of correlation of pins. FIG. 20 illustrates an example of superposition of a post-replacement component and a pre-replacement component. When reverse correlation is performed, a user instructs rotation of the post-replacement component via the input unit 130. As depicted in FIG. 19, the correlation processing unit 114 rotates the post-replacement component in a counterclockwise fashion, for example, in accordance with an instruction. In a rightmost state of FIG. 19, a user instructs the correlation via the input unit 130. The correlation processing unit 114 directly superposes the post-replacement component and the pre-replacement component on each other on a work layer and determines that the post-replacement component is accorded with the pre-replacement component in a certain allowance range, correlating pin numbers, for example. When the superposition depicted in FIG. 19 is performed, a pin having the pin number “1” of the pre-replacement component is correlated with a pin having the pin number “K” of the post-replacement component and a pin having the pin number “2” of the pre-replacement component is correlated with a pin having the pin number “A” of the post-replacement component, generating correlation data as depicted in FIG. 20. Rotation may be performed, or editing processing such as inversion, movement, enlargement, or reduction may be performed. A content of edition processing such as a rotation angle may be held. Similar editing processing for symbols of post-replacement components on other associated work layers may be executed before execution of replacement processing. At this time, the symbol editing unit 112 may execute similar editing processing with respect to symbols of post-replacement components on the associated work layers.

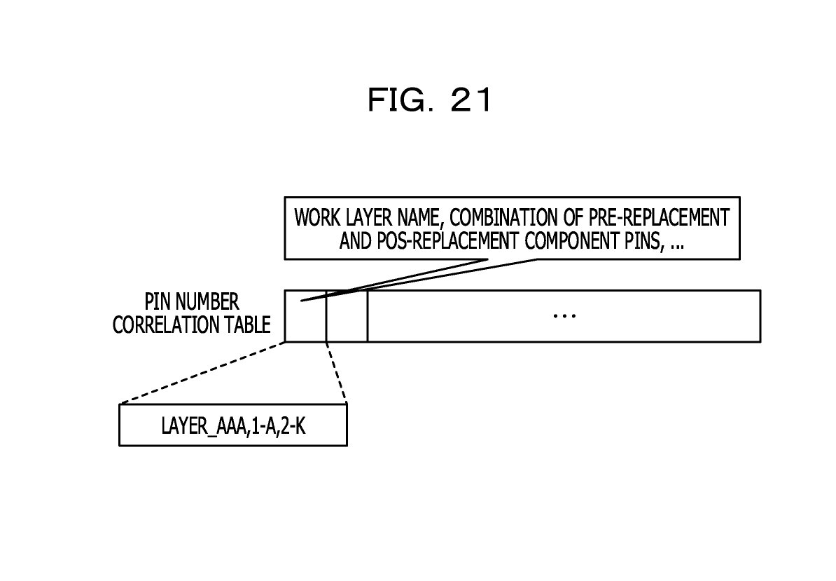

FIG. 21 illustrates an example of a pin number correlation table. Correlation data is registered on the pin number correlation table depicted in FIG. 21, in the correlation storage unit 124. In FIG. 21, a work layer name and a combination of pre-replacement and pos-replacement component pins are stored. In a case of the correlation depicted in FIG. 18, combinations of pre-replacement and post-replacement component pins which are a combination “1-A” and a combination “2-K” may be included in the number of pins. Replacement of components of a plurality of categories may be simultaneously performed or replacement of only one category may be performed.

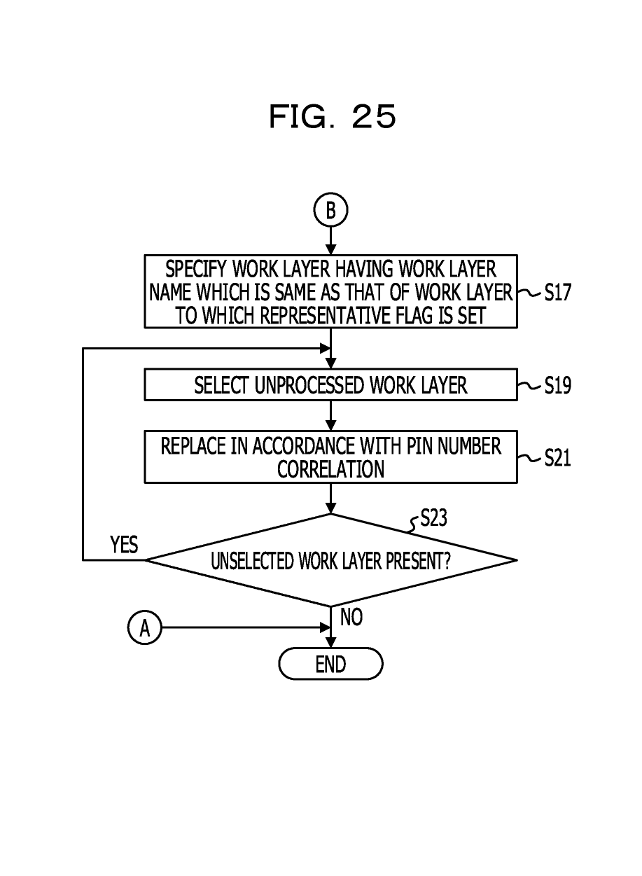

The control unit 110 allows the display unit 140 to display for asking a user whether or not association correction is performed, and receives an input from the user. The control unit 110 determines whether or not to perform correction of association in accordance with the input for correction or no correction which is inputted from the input unit 130 (operation S13). In a case of no correction, the processing shifts to processing illustrated in FIG. 25 via a terminal B.

When correction of association is performed, the layer editing unit 111 promotes a user to select a component to which association cancellation is to be performed, via the display unit 140, because the above-described association is performed based on a work layer name. When the input from the user is received, a work layer name related to a component to which association cancellation is to be performed is changed (operation S15).

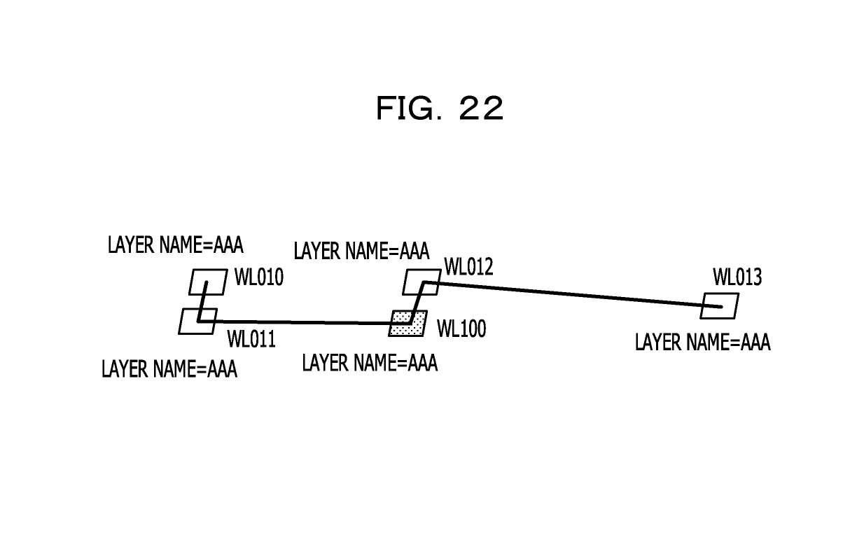

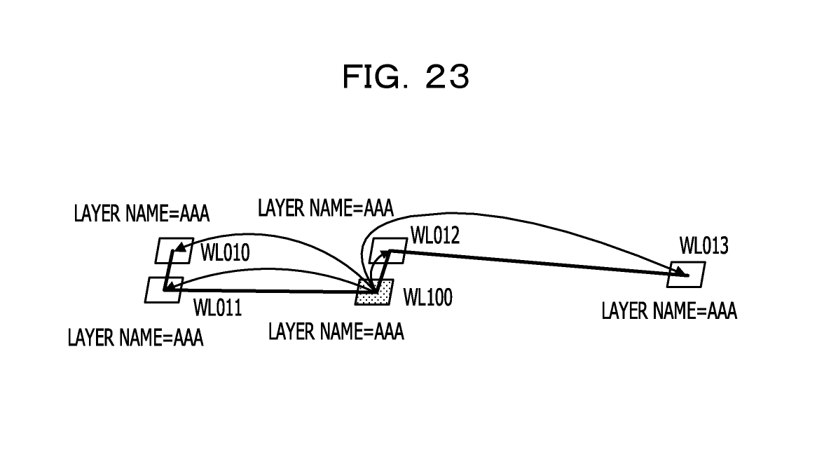

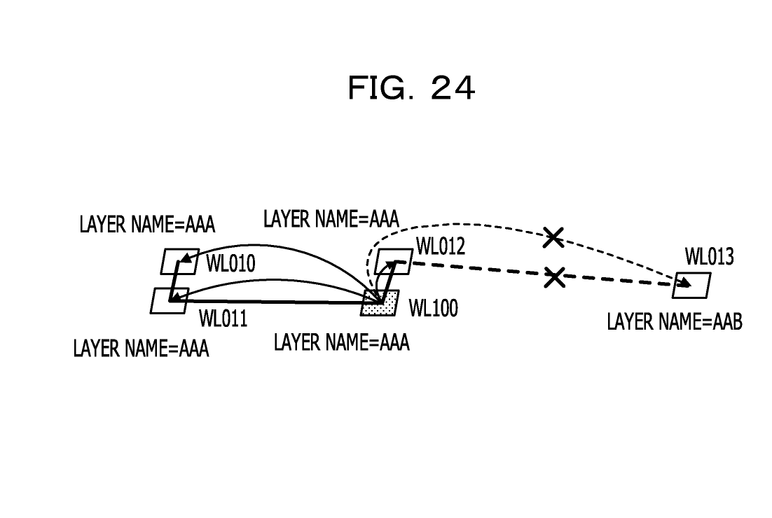

FIG. 22 illustrates an example of association cancellation. FIG. 23 illustrates an example of association cancellation. FIG. 24 illustrates an example of association cancellation. As schematically depicted in FIG. 22, identical work layer names “AAA” are respectively provided to work layers which are generated for pre-replacement components in one category at an early state, and thus work layers WL010 to WL013 and WL100 to which the identical work layer names “AAA” are respectively provided are associated with each other. Correlation of pin numbers which is performed by a user with respect to the representative work layer WL100 is applied with no change to the work layers WL010 to WL013 which have the same work layer name “AAA”, as schematically depicted in FIG. 23. When association cancellation of a pre-replacement component in the work layer WL013 is designated or when the work layer WL013 is directly designated in operation S15, for example, the work layer name of the work layer WL013 is changed into “AAB” as schematically depicted in FIG. 24. A work layer name after change may be designated by a user or may be automatically changed based on a predetermined rule such as a rule for avoiding duplication with other work layer names. Cancellation of association with work layers having the work layer name “AAA” brings non-application of correlation of pin numbers with respect to the work layer WL013. The processing shifts to processing illustrated in FIG. 25 via the terminal B.

FIG. 25 illustrates an example of support processing of circuit designing. In FIG. 25, the replacement processing unit 113 specifies a work layer having a work layer name same as a work layer name of a work layer to which a representative flag is set in a work layer management table in the layer storage unit 123 (operation S17).

In a state as depicted in FIG. 24, since the work layer WL100 is a representative work layer to which a representative flag is set, the work layers WL010 to WL012 which have the work layer names same as the work layer name “AAA” of the work layer WL100 are specified.

The replacement processing unit 113 selects one unprocessed work layer among the specified work layers (operation S19). The replacement processing unit 113 reads correlation data of a pin number for the work layer name of the representative work layer from the pin number correlation table which is stored in the correlation storage unit 124 and performs replacement of a post-replacement component on the selected work layer and a pre-replacement component in accordance with the correlation data (operation S21). When a symbol of the post-replacement component depicted in FIG. 19 is rotated based on the pin number correlation data, the replacement processing unit 113 performs replacement after allowing the symbol editing unit 112 to rotate the symbol of the post-replacement component on the work layer similarly to the editing processing which has been performed with respect to the symbol of the post-replacement component on the representative work layer.

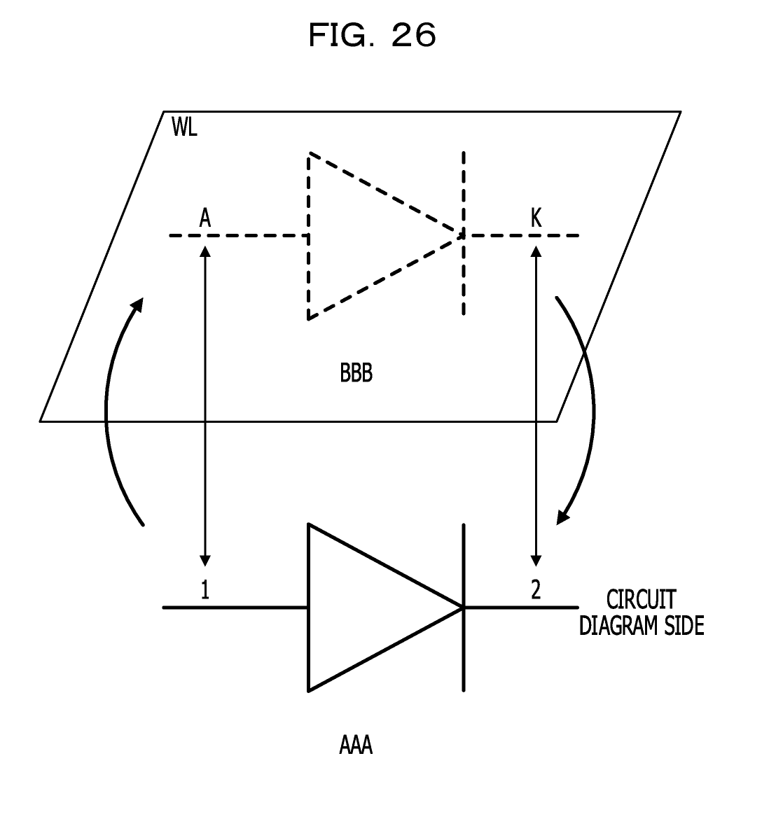

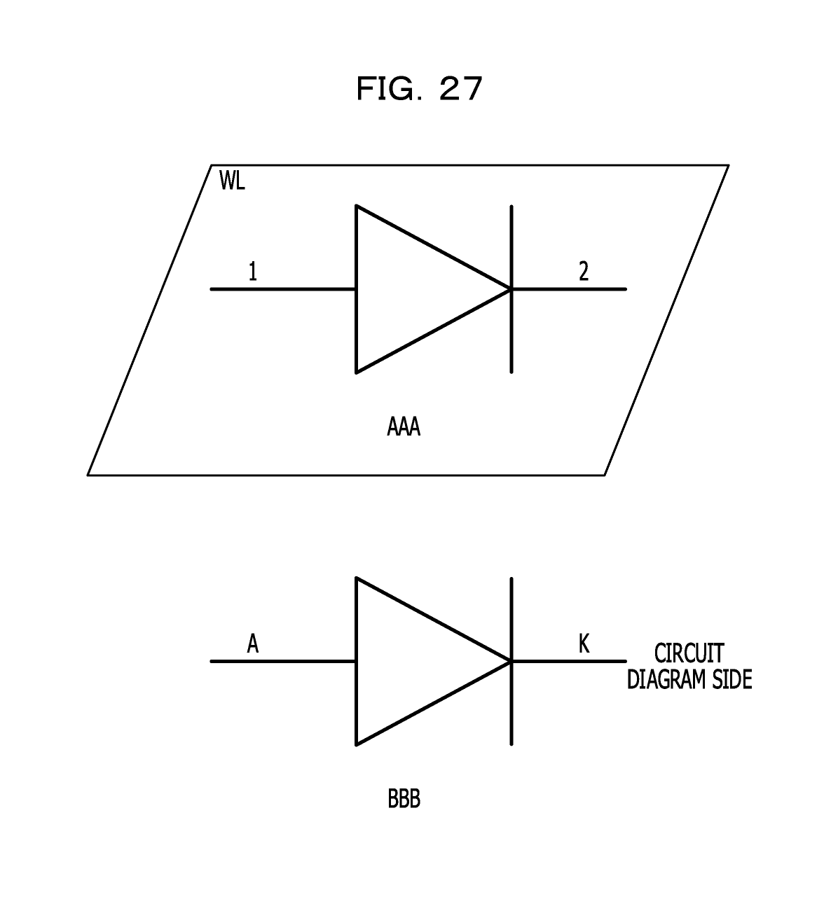

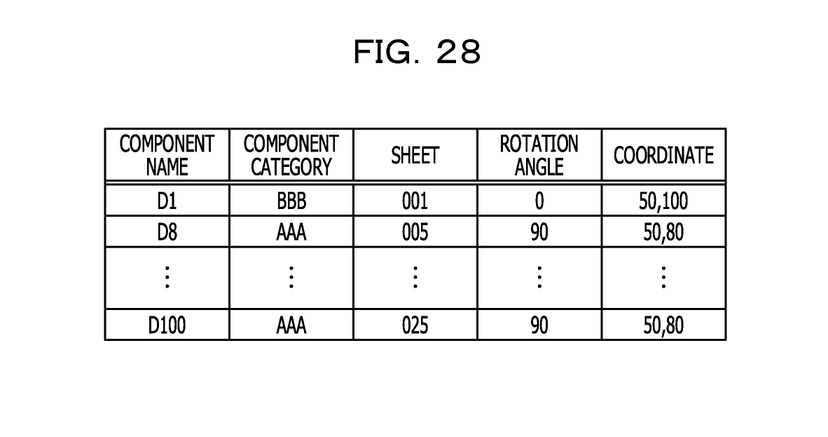

FIG. 26 illustrates an example of replacement processing. FIG. 27 illustrates an example of replacement processing. FIG. 28 illustrates an example of data which is stored in a component storage unit after replacement. For example, when the pin number “1” of the pre-replacement component is correlated with the pin number “A” of the post-replacement component and the pin number “2” of the pre-replacement component is correlated with the pin number “K” of the post-replacement component as depicted in FIG. 18, a state which is schematically depicted in FIG. 26 is arranged and then the post-replacement component on a work layer and the pre-replacement component of a circuit diagram are replaced with each other. As depicted in FIG. 27, the post-replacement component is arranged on a circuit diagram and a pre-replacement component is arranged on the work layer. The work layer is not used after the replacement, so that the work layer may be discarded.

When processing of the first replacement is performed with respect to a component on the first line in the example of the component data (FIG. 10) which is stored in the component storage unit 121, the component category is changed into “BBB” as depicted in FIG. 28. Following component categories are sequentially changed into “BBB” by executing similar replacement processing.

The replacement processing unit 113 determines whether or not an unselected work layer is present in specified work layers (operation S23). When an unselected work layer is present, the processing returns to operation S19. When an unselected work layer is not present, the processing is ended.

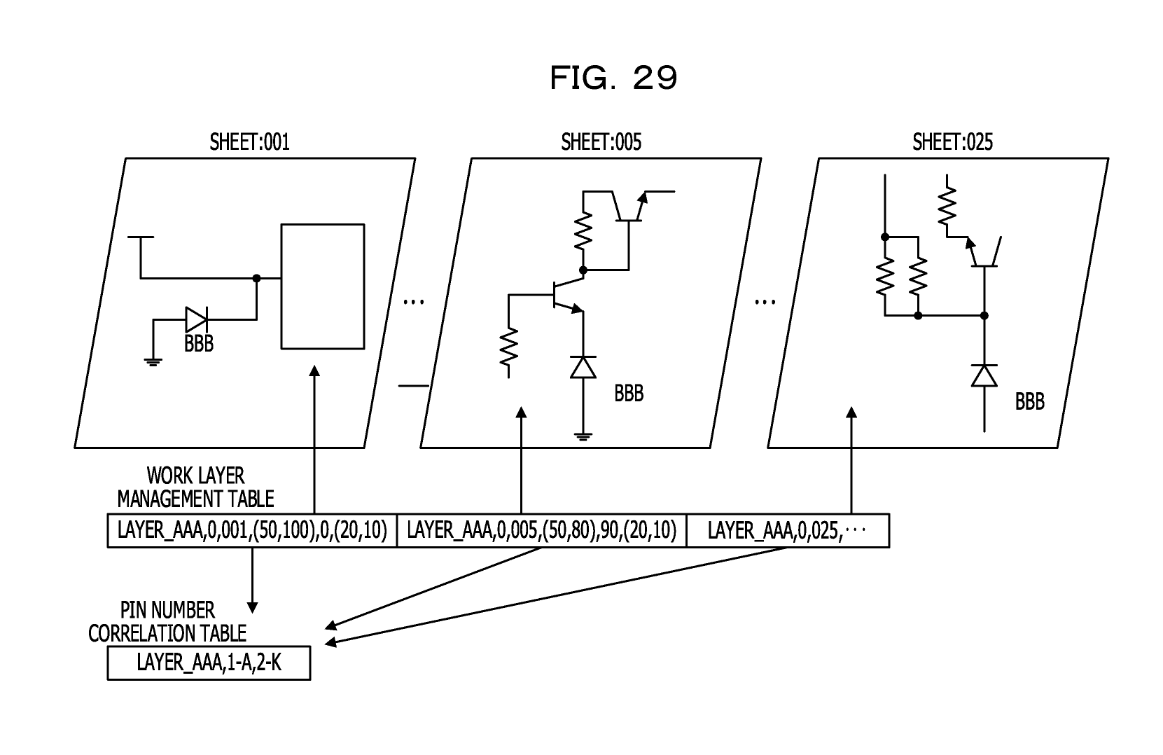

FIG. 29 illustrates an example of replacement processing. When the above-described replacement processing is executed with respect to pre-replacement components of the component category “AAA” of respective sheets depicted in FIG. 13, for example, a post-replacement component on a work layer and a pre-replacement component are replaced with each other in accordance with pin number correlation data which is registered on a pin number correlation table which is depicted in the lower side of FIG. 29, based on a work layer management table which is depicted in the center of FIG. 29. Through the replacement, post-replacement components of the component category “BBB” are arranged on a circuit diagram, as depicted in the upper side of FIG. 29.

Even when representing methods of pin numbers are different, component replacement may be efficiently performed due to the above-described processing.

For example, the CAD device depicted in FIG. 7 may be a functional block diagram and may not be accorded with the program module configuration. A storage unit may hold similar data and may have another configuration.

In the processing flow, a processing order may be changed and the processing may be executed in parallel, as long as a processing result does not change.

Association of work layers may be performed based on a work layer name. A list of work layers to be associated may be generated separately so as to perform association, and association may be performed by other methods.

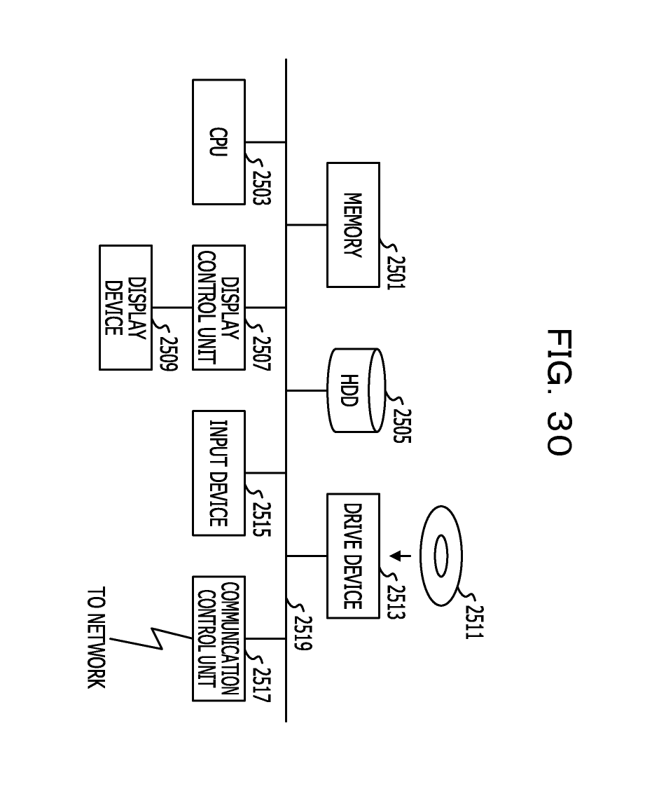

FIG. 30 illustrates an example of a computer. The CAD device 100 is a computer device. As depicted in FIG. 30, a memory 2501, a central processing unit (CPU) 2503, a hard disk drive (HDD) 2505, a display control unit 2507 which is connected with a display device 2509, a drive device 2513 for a removable disk 2511, an input device 2515, and a communication control unit 2517 for connection to a network are connected with each other via a bus 2519. An operating system (OS) and an application program for executing the above-described processing are stored in the HDD 2505. When the OS and the application program are executed by the CPU 2503, the OS and the application program are read from the HDD 2505 on the memory 2501. The CPU 2503 controls the display control unit 2507, the communication control unit 2517, or the drive device 2513 in accordance with a processing content of the application program so as to allow the display control unit 2507, the communication control unit 2517, or the drive device 2513 to perform a predetermined operation. Data in process may be stored in the memory 2501 or stored in the HDD 2505. The application program for executing the above-described processing is stored in the removable disk 2511 which is readable by a computer and is distributed so as to be installed on the HDD 2505 from the drive device 2513. The application program may be installed on the HDD 2505 via a network such as Internet and the communication control unit 2517. In the computer device, hardware such as the CPU 2503 and the memory 2501 and a program such as an OS and an application program may organically collaborate so as to execute the above-described various functions.

An information processing method includes (A) processing for specifying first components that are included in data of a circuit diagram, which includes a plurality of components, when receiving an instruction to replace the first components of a first category with second components of a second category, (B) processing for generating layers on which the second components are to be respectively arranged with respect to the respective first components that are specified, (C) processing for acquiring correlation between a pin of the first components and a pin of the second components, and (D) processing for replacing the first components in the data of the circuit diagram with the second components that are respectively arranged on the layers, in accordance with the correlation.

Designing data such as a circuit diagram is not expressed in a hierarchical structure, but a layer is generated to tentatively arrange post-replacement components. After replacement of components, the generated layer may not be included in data of the circuit diagram. A layer is generated with respect to each of the first components of the first category, so that replacement processing may be efficiently performed even when representing methods of pin numbers of components are different from each other.

For example, the above-described generating processing may include processing for associating layers. The information processing method may further include processing for cancelling association among associated layers in accordance with an instruction. In the replacement processing, replacement for respective associated layers may be executed. Due to the association, correlation may be efficiently applied to a plurality of first components.

For example, the above-described specifying processing may include processing for specifying data indicating a position and an angle of the first component in a circuit diagram and processing for specifying data indicating a region size of a symbol of the first component.

For example, the above-described generating processing may include processing for generating respective layers so that each layer is accorded with a position, an angle, and a region size which are specified in the specifying processing. A layer having a suitable size may be generated on a suitable position.

For example, association of layers may be performed based on names of the layers or based on other data configurations.

For example, the above-described acquisition processing may include editing processing with respect to a symbol of the second component in accordance with an instruction, such as processing for acquiring correlation based on a position of a pin of the second component which has been rotated or moved, for example, and a position of a pin of the first component. Correlation of pin numbers may be inputted by a user.

For example, the above-described processing may be created as a program which is to be executed by a computer. The program may be stored in a computer-readable storage medium such as a flexible disk, an optical disk such as a CD-ROM, a magnet-optical disk, a semiconductor memory (for example, a ROM), and hard disk, or a storage device, for example.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing method, comprising:
identifying, by a computer, a first components of a first category included in circuit data including a plurality of components, when receiving a first instruction to replace the first components with a second component of a second category;
generating layers on which the second component is to be arranged;
acquiring correlation between a pin of the first component and a pin of the second component; and
replacing the first component with the second component arranged on the layers based on the correlation.

2. The information processing method according to claim 1, further comprising:
associating the layers with each other; and
cancelling the association in accordance with a second instruction.

3. The information processing method according to claim 2, wherein replacement is performed on the associated layers.

4. The information processing method according to claim 1, further comprising:
identifying data indicating a position and an angle of the first component; and
identifying data indicating a region size of a symbol of the first component.

5. The information processing method according to claim 4, further comprising:
generating the layers so as to be accorded with the position, the angle, and the region size.

6. The information processing method according to claim 1, wherein the association of the layers is performed based on a name of the layers.

7. The information processing method according to claim 1, further comprising:
acquiring the correlation based on a pin position of the second component and a pin position of the first component, the pin position of the second components being obtained after editing a symbol of the second component, in accordance with an instruction.

8. An information processing device, comprising:
a generation unit configured to identify a first components of a first category included in circuit data including a plurality of components, when receiving a first instruction to replace the first components with a second component of a second category, and generate layers on which the second component is to be arranged;
an acquisition unit configured to acquire correlation between a pin of the first component and a pin of the second component; and
a replacement unit configured to replace the first component with the second component arranged on the layers based on the correlation.

9. The information processing device according to claim 8, wherein, the layers are associated with each other and the association is cancelled in accordance with a second instruction.

10. The information processing device according to claim 8, wherein the replacement unit performs replacement on the associated layers.

11. The information processing device according to claim 8, wherein the generation unit identifies data indicating a position and an angle of the first component and identifies data indicating a region size of a symbol of the first component.

12. The information processing device according to claim 11, wherein the generation unit generates the layers so as to be accorded with the position, the angle, and the region size.

13. The information processing device according to claim 8, wherein the association of the layers is performed based on a name of the layers.

14. The information processing device according to claim 8, wherein the acquisition unit acquires the correlation based on a pin position of the second component and a pin position of the first component, the pin position of the second components being obtained after editing a symbol of the second component, in accordance with an instruction.

15. An information processing system, comprising:
a CPU; and
a memory configured to store a program that is executed by the CPU;
wherein the program includes operations:
identifying, by a computer, a first components of a first category included in circuit data including a plurality of components, when receiving a first instruction to replace the first components with a second component of a second category;
generating layers on which the second component is to be arranged;
acquiring correlation between a pin of the first component and a pin of the second component; and
replacing the first component with the second component arranged on the layers based on the correlation.

16. The information processing system according to claim 15, further comprising:
associating the layers with each other; and
cancelling the association in accordance with a second instruction.

17. The information processing system according to claim 15, wherein replacement is performed on the associated layers.

18. The information processing system according to claim 15, further comprising:
identifying data indicating a position and an angle of the first component; and
identifying data indicating a region size of a symbol of the first component.

19. The information processing system according to claim 15, wherein the association of the layers is performed based on a name of the layers.

20. The information processing system according to claim 15, further comprising:
acquiring the correlation based on a pin position of the second component and a pin position of the first component, the pin position of the second components being obtained after editing a symbol of the second component, in accordance with an instruction.
